(19) United States
(12) Patent Application Publication
(10) Pub. No.: US 2023/0023756 A1
(43) Pub. Date: Jan. 26, 2023

(54) DEVICE AND METHOD FOR PRODUCT OWNERSHIP MANAGEMENT

(71) Applicant: Honda Motor Co., Ltd., Tokyo (JP)

(72) Inventors: Tiffany Tam, Palos Verdes Estates, CA (US); Shinngaram Choi, Torrance, CA (US); Dillon Kane, Kane, CA (US)

(21) Appl. No.: 17/383,288

(22) Filed: Jul. 22, 2021

(51) Int. Cl. G06F 21/10; G06Q 30/06

(52) U.S. Cl. CPC G06F 21/105; G06Q 30/0619; G06Q 30/0645; G06Q 30/0627; G06Q 30/0639

(57) ABSTRACT

A first computing device for product ownership management is provided. The first computing device is communicatively coupled to a store management system of a retail store. The circuitry determines a first geo-location associated with the first computing device. The circuitry receives credit information, associated with a purchase of a first product by a first user of the first computing device, from the store management system. The credit information may include a second geo-location associated with purchase of the first product. The circuitry compares the first geo-location and the second geo-location and receives product information associated with the purchased first product, based on the comparison. The circuitry stores the received product information and further generates ownership information for the purchased first product via an ownership management software. The circuitry further controls a display screen to display the stored product information and the generated ownership information.

### BACKGROUND

Recent advancements in the field of information technology have led to development of various software applications that may be installed on computing devices (such as, smartphones, tablets, and personal computers) and may be used for management of products purchased by a user (such as, an owner of the product). Conventionally, the user may feed details of a purchased product to such software application based on a serial number or other details of the purchased product. This may require manual inputs by the user, such as, through an entry or scan of the serial number of the purchased product in the software application of the computing device. Thereafter, the details related to the product may be stored in the software application for management of the purchased product. However, the entry of the serial number or other details based on the manual inputs by the user may be prone to errors and also may be a time consuming process.

Further limitations and disadvantages of conventional and traditional approaches will become apparent to one of skill in the art, through comparison of described systems with some aspects of the present disclosure, as set forth in the remainder of the present disclosure and with reference to the drawings.

### SUMMARY

According to an embodiment of the disclosure, a first computing device for product ownership management is provided. The first computing device may include circuitry communicatively coupled to a store management system of a retail store. The circuitry may determine a first geo-location associated with the first computing device. The circuitry may receive credit information, associated with a purchase of a first product by a first user of the first computing device, from the store management system. The received credit information may include a second geo-location associated with the purchase of the first product. The circuitry may compare the determined first geo-location and the second geo-location associated with the purchase of the first product. The circuitry may receive product information associated with the purchased first product from the store management system, based on the comparison. The circuitry may store the received product information associated with the purchased first product. Based on the stored product information, the circuitry may generate ownership information for the purchased first product via an ownership management software associated with the first computing device. The circuitry may control a display screen to display the stored product information and the generated ownership information associated with the purchased first product.

According to another embodiment of the disclosure, a method for product ownership management is provided. The method may be performed by a first computing device communicatively coupled to a store management system of a retail store. The method by include a determination of a first geo-location associated with the first computing device. The method may further include a reception of credit information, associated with a purchase of a first product by a first user of the first computing device, from the store management system. The received credit information may include a second geo-location associated with the purchase of the first product. The method may further include a comparison of the determined first geo-location and the second geo-location associated with the purchase of the first product. The method may further include a reception of product information associated with the purchased first product from the store management system, based on the comparison. The method may further include a storage of the received product information associated with the purchased first product. The method may further include, based on the stored product information, generation of ownership information for the purchased first product via an ownership management software associated with the first computing device. The method may further include control of a display screen to display of the stored product information and the generated ownership information associated with the purchased first product.

According to another embodiment of the disclosure, there is provided a non-transitory computer-readable medium having stored thereon, computer-executable instructions that when executed by a first computing device, causes the first computing device to execute operations. The first computing device may be communicatively coupled to a store management system of a retail store. The operations may include determining a first geo-location associated with the first computing device. The operations may further include receiving credit information, associated with a purchase of a first product by a first user of the first computing device, from the store management system. The received credit information comprises a second geo-location associated with the purchase of the first product. The operations may further include comparing the determined first geo-location and the second geo-location associated with the purchase of the first product. The operations may further include receiving product information associated with the purchased first product from the store management system, based on the comparison. The operations may further include storing the received product information associated with the purchased first product. The operations may further include based on the stored product information, generating ownership information for the purchased first product via an ownership management software associated with the first computing device. The operations may further include controlling a display screen to display the stored product information and the generated ownership information associated with the purchased first product.

### BRIEF DESCRIPTION OF THE DRAWINGS

FIG. 1 is a block diagram that illustrates an exemplary environment for product ownership management on a first computing device, in accordance with an embodiment of the disclosure.

FIG. 2 is a block diagram that illustrates an exemplary first computing device for product ownership management, in accordance with an embodiment of the disclosure.

FIGS. 3A and 3B, collectively, illustrate an exemplary processing pipeline for product ownership management on a first computing device, in accordance with an embodiment of the disclosure.

FIGS. 4, 5, 6, and 7 illustrate exemplary processing pipelines for update of product profile via an ownership management software associated with a first computing device, in accordance with an embodiment of the disclosure.

FIG. 8 is a diagram that illustrates an exemplary scenario for product ownership management on a first computing device, in accordance with an embodiment of the disclosure.

FIG. 9 is a flowchart that illustrates an exemplary method for product ownership management on a first computing device, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Various embodiments of the present disclosure may be found in a first computing device for product ownership management. The first computing device (such as a smartphone, or a tablet) may be communicatively coupled to a store management system of a retail store. The first computing device may display product information (such as product name, product identification number, etc.) and ownership information associated with a product (such as, but is not limited to, an automobile, a power equipment, an entertainment equipment, a marine equipment, or a decorative item) purchased by a first user of the first computing device. The first computing device may determine a first geo-location associated with the first computing device. Once a first product may be purchased, the first computing device may receive credit information from the store management system, where the credit information may be associated with the purchase of the first product by the first user of the first computing device. The received credit information may include a second geo-location associated with the purchase of the first product. The second geo-location may indicate a location of the retail store from where the first product may be purchased by the first user of the first computing device. For example, the received credit information may further include, but is not limited to a date and time of the purchase of the first product, a mode of payment for the purchase of the first product, or invoice details associated with the purchase of the first product.

The first computing device may compare the determined first geo-location and the second geo-location associated with the purchase of the first product. Based on the comparison, the first computing device may receive the product information associated with the purchased first product from the store management system. In case, the first geo-location is determined as same as the second geo-location, a physical location of the first user at the time of the purchase may be determined as same as that of the retail store. In such case, the first product and the purchase of the first product may be determined as legitimate, and the product information associated with the purchased first product may be automatically received from the store management system. For example, the received product information may include, but is not limited to a product identification number, a product name, product license information, product usage terms, or a warranty period associated with the purchased first product. The first computing device may further store the received product information associated with the purchased first product. Based on the stored product information, the first computing device may generate ownership information associated with the purchased first product via an ownership management software associated with the first computing device. For example, the generated ownership information may indicate, but is not limited to, information about an owner of the purchased first product and a time interval associated with the ownership of the purchased first product by the owner. The first computing device may further control a display screen to display the stored product information and the generated ownership information associated with the purchased first product.

The disclosed first computing device may dynamically receive the product information associated with the purchased first product, when the determined first geo-location of the first computing device matches with the second geo-location associated with the purchase of the first product from the retail store. If the first geo-location and the second geo-location matches, this may indicate that the first user may be physically present at a location of the retail store at the time of the purchase of the first product. Thus, the matching of the first geo-location and the second geo-location may ensure that the purchase of the first product from the retail store may be legitimate and that the product information may be received for such genuine product purchase transaction. Also, the ownership management software or application (i.e. installed or configured on the first computing device) may automatically generate the ownership information related to the first product based on the received product information. The ownership information may indicate that the first product is now purchased and owned by the first user of the first computing device. Such automatic generation may eliminate a need for the first user (or for a person related to the retail store) to manually enter (or scan) a product identification number (such as, a serial number) of the purchased first product into the ownership management software, and later manage the purchased first product based on information (i.e. about the first product) added in the ownership management software. The automatic entry of the product information of the purchased first product may be less prone to errors than manual data input and may also be less time consuming. In an embodiment, an ownership of the purchased first product may be further managed through the ownership management software on the first computing device. For example, different operations for the first product, such as rent, exchange, or selling may be managed by use of the ownership management software, based on the product information and the ownership information associated with the purchased first product. Thus, the ownership of the purchased first product may be effectively managed through the ownership management software installed on the first computing device.

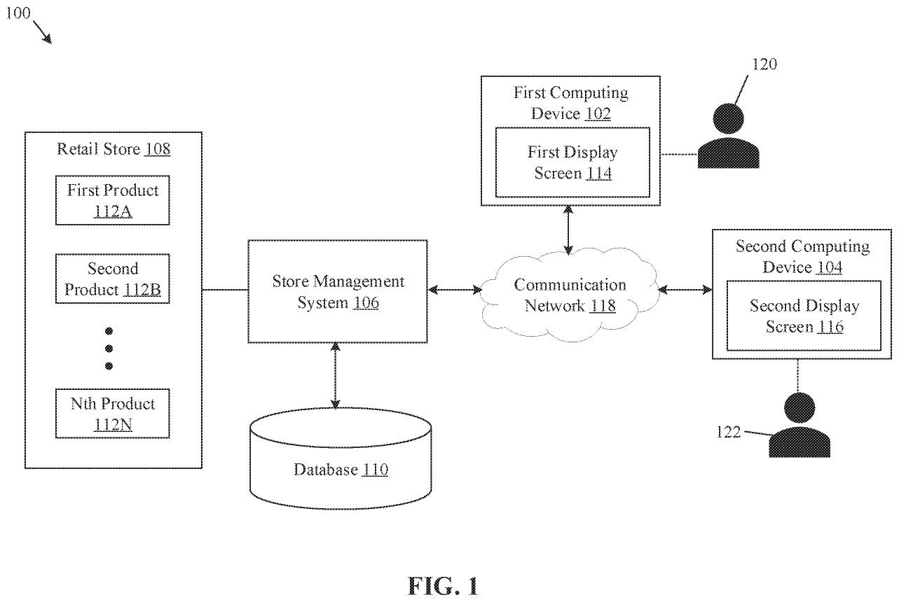

FIG. 1 is a block diagram that illustrates an exemplary environment for product ownership management on a first computing device, in accordance with an embodiment of the disclosure. With reference to FIG. 1, there is shown a network environment 100. The network environment 100 may include a first computing device 102, a second computing device 104, and a store management system 106. The network environment 100 may further include a retail store 108, and a database 110 associated with the store management system 106. In an embodiment, the store management system 106 may be related (or owned) by the retail store 108. The retail store 108 may sell, rent, or exchange one or more products (such as a first product 112A, a second product 112B, . . . , and an Nth product 112N). The N number of one or more products shown in FIG. 1 is presented merely as an example. The retail store 108 in the network environment 100 of FIG. 1 may include more or less than N number of products, without departure from the scope of the disclosure.

The first computing device 102 and the second computing device 104 may further include a first display screen 114 and a second display screen 116, respectively. The first computing device 102, and the second computing device 104, and the store management system 106 may be communicatively coupled with each other, via a communication network 118. In the network environment 100, there is further shown a first user 120 associated with the first computing device 102, and the second user 122 associated with the second computing device 104. It may be noted that, the first computing device 102 and the second computing device 104 shown in FIG. 1 is presented merely as an example. The network environment 100 of FIG. 1 may include more or less than two computing devices, without departure from the scope of the disclosure.

The first computing device 102 may include suitable logic, circuitry, interfaces, and/or code that may enable a user (e.g., the first user 120) of the first computing device 102 to manage product ownership associated with one or more products purchased by the first user 120. In an embodiment, the first computing device 102 may include a web client to access a client-side application or may include an installed software application for ownership management (e.g., an ownership management software). In an embodiment, the ownership management software may be associated with a manufacturer of the first computing device 102 or a manufacturer of the first product 112A. The ownership management software may include a user interface (UI) to execute several operations, such as, but not limited to, to a rent operation, an exchange operation, a purchase operation, or a sale operation of the one or more purchased products that may be managed by the ownership management software. The user interface (UI) of the ownership management software may further display product information and ownership information associated with the purchased one or more products. The ownership management software may be installed on the first computing device 102. For example, the first user 120 may choose to rent the first product 112A to the second user 122, via the ownership management software. The first computing device 102 may generate the ownership information including a time interval for which the first product 112A is to be rented to the second user 122.

The first computing device 102 may control the first display screen 114 to display the product information and the ownership information associated with the one or more purchased products, via the ownership management software. Examples of the first computing device 102 may include, but are not limited to, a mobile phone, a smartphone, a cellular phone, a tablet computing device, a computer work-station, a personal computer, a gaming device, a server, a mainframe machine, a consumer electronic (CE) device, or any computing device with an inbuilt or installed web-client or a software application that may be associated (or may communicate) with the store management system 106.

The first display screen 114 may include suitable logic, circuitry, and interfaces that may display an output of the first computing device 102. The first display screen 114 may be utilized to display the product information and the ownership information associated with the one or more purchased products. The first display screen 114 may be utilized to further display the user Interface (UI) of the ownership management software. In some embodiments, the first display screen 114 may be an external display device associated with the first computing device 102. The first display screen 114 may be a touch screen which may enable the first user 120 to provide a user input via the first display screen 114. The touch screen may be at least one of a resistive touch screen, a capacitive touch screen, a thermal touch screen or any other touch screen using which inputs can be provided to the first display screen 114. The first display screen 114 may be realized through several known technologies such as, but not limited to, at least one of a Liquid Crystal Display (LCD) display, a Light Emitting Diode (LED) display, a plasma display, or an Organic LED (OLED) display technology, or other display devices.

The functions of the second computing device 104, and the second display screen 116 may be same as the functions of the first computing device 102, and the first display screen 114, respectively. Therefore, the description of the second computing device 104, and the second display screen 116 is omitted from the disclosure for the sake of brevity.

The store management system 106 may include suitable logic, circuitry, interfaces, and/or code that may enable a management of operations or products of the retail store 108 or a chain of the retail stores. The store management system 106 may include a set of tools, such as, but not limited to, an inventory management system, a supply chain management system, a point-of-sale (PoS) management system, or an accounting management system. The store management system 106 may enable, for example, the retail store 108 to manage at least one of, but not limited to, an inventory of the one or more products, a date and time of the purchase of the one or more products, a mode of payment for the purchase of the one or more products, invoice details associated with the purchase of the one or more products, or information about an owner who purchase the product of the retail store 108.

In an embodiment, the store management system 106 may use the database 110 to store information related to the one or more products. Such information may be automatically provided to the first computing device 102 based on the purchase of one or more products. The stored information may include, for example, the credit information, or the product information associated with the one or more products. In one embodiment, the store management system 106 may be an on-premises system located at the facility of the retail store 108. In another embodiment, the store management system 106 may be located outside the premises of the retail store 108. For example, the store management system 106 may be an edge computing device, a fog-computing system (with at least one edge node located near the premises of the retail store 108), or a set of distributed computing devices. Alternatively, the store management system 106 may be a server (such as a cloud server). Other examples of the store management system 106 may include, but are not limited to, a SaaS application server, a database server, a distributed computing server, a mainframe system, a work-station, a personal computer, or a mobile device.

The retail store 108 may be a physical store that may sell, rent, or exchange products (which may include goods, services, or a combination thereof) available at the retail store 108 (or at its warehouses, a dealer place, or nearby stores chains). The retail store 108 may be organized into different departments to organize the one or more products. For example, as shown in FIG. 1, the retail store 108 may include the one or more products, such as, but not limited to, the first product 112A, the second product 112B, . . . , and the Nth product 112N. Examples of the one or more products may include, but are not limited to, a power equipment, an automobile, a marine equipment, a decorative item, an educational item, an entertainment product, a health-related product, a furniture item, a clothing product, or a sports-related product.

The database 110 may store the information related to, for example, the retail store 108, the credit information, and the product information associated with the one or more products. Such information may be dynamically provided to the first computing device 102 communicatively coupled to the store management system 106. The database 110 may be a relational or a non-relational database. The database 110 may be stored on a device, such as the store management system 106, or a server different from the store management system 106 and the first computing device 102. The device which stores the database 110 may receive a request from the first computing device 102, through the communication network 118. Based on the received request, the device may retrieve the credit information and the product information from the database 110 and may transmit the credit information and the product information to the first computing device 102, through the communication network 118. In an embodiment, the store management system 106 may transmit the credit information and the product information to the first computing device 102 based on the purchase of the product by the first user 120 of the first computing device 102.

The communication network 118 may include a communication medium through which the first computing device 102, and the second computing device 104 may be communicatively coupled to the store management system 106. Examples of the communication network 118 may include, but are not limited to, the Internet, a cloud network, a Wireless Fidelity (Wi-Fi) network, a Personal Area Network (PAN), a Local Area Network (LAN), or a Metropolitan Area Network (MAN), a mobile wireless network, such as a Long-Term Evolution (LTE) network (for example, 4th Generation or 5th Generation (5G) mobile network (i.e., 5G New Radio)). Various devices of the network environment 100 may connect to the communication network 118, in accordance with various wired or wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, Bluetooth (BT) communication protocols, or a combination thereof.

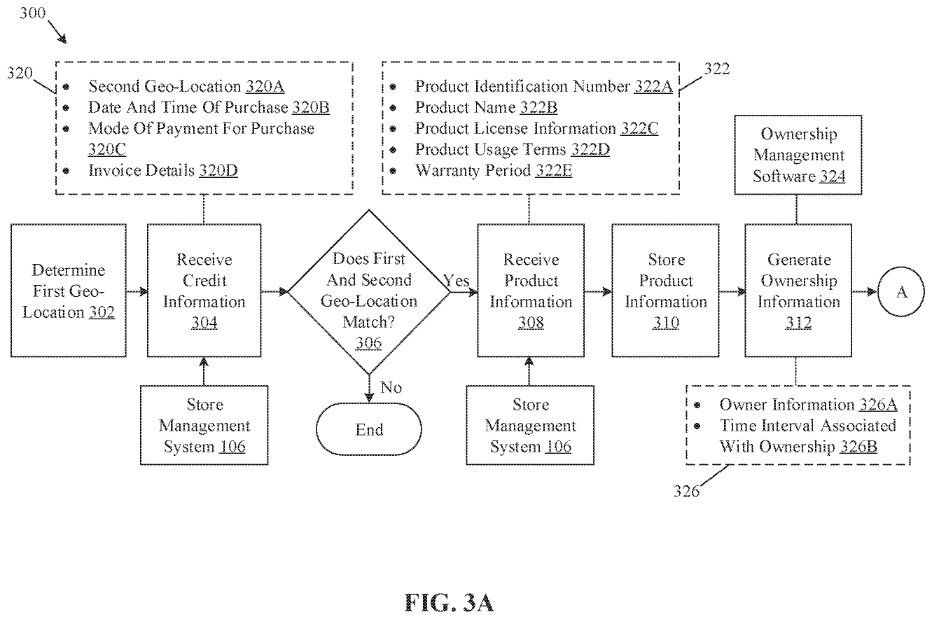

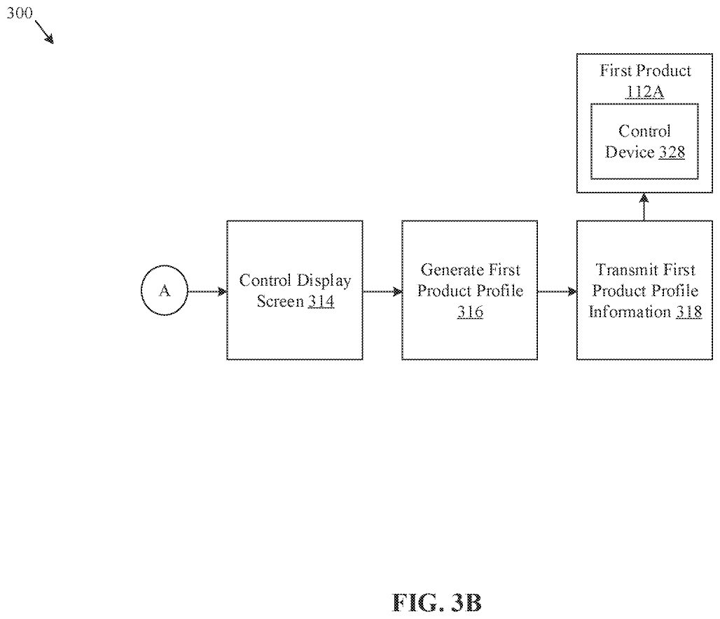

In operation, the first computing device 102 may determine a first geo-location associated with the first computing device 102. The determination of the first geo-location is described, for example in FIGS. 3A, and 3B. For example, the first geo-location may correspond to a place (like a street, a locality, a city, a state, or a country) to which a current geo-location associated with the first user 120 may belong. Based on the purchase of the first product 112A by the first user 120, the first computing device 102 may receive credit information associated with the purchase of the first product 112A from the store management system 106. The first product 112A may be purchased by the first user 120 from the retail store 108. Examples of the received credit information, may include, but is not limited to, a second geo-location associated with the purchase of the first product 112A, a date and time of the purchase of the first product 112A, a mode of payment for the purchase of the first product 112A, or invoice details associated with the purchase of the first product 112A. The retrieval of the credit information is described, for example, in FIGS. 3A, and 3B.

The first computing device 102 may further compare the determined first geo-location and the second geo-location associated with the purchase of the first product 112A, as described, for example, in FIGS. 3A, and 3B. Based on the comparison, the first computing device 102 may receive product information associated with the purchased first product 112A from the store management system 106. Examples of the received product information may include, but is not limited to, a product identification number (e.g., a vehicle identification number in case of a vehicle), a product name (e.g., a product name and series, a product brand, and a product type), product license information, product usage terms, or a warranty period associated with the purchased first product 112A. The retrieval of the product information is described, for example, in FIGS. 3A, and 3B.

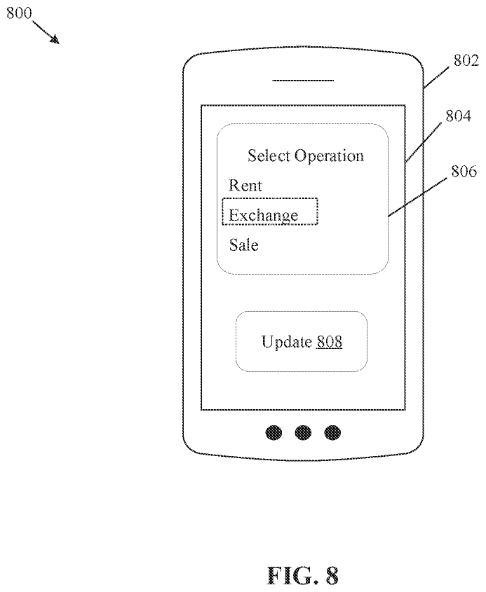

The first computing device 102 may store the received product information associated with the purchased first product 112A. Based on the stored product information, the first computing device 102 may generate ownership information associated with the purchased first product 112A, via the ownership management software associated with (or installed on) the first computing device 102. Example of the generated ownership information may include, but is not limited to, information about an owner of the purchased first product 112A, and a time interval associated with the ownership of the purchased first product 112A by the owner (such as the first user 120). The generation of the ownership information is described for example, in FIGS. 3A, and 3B. The first computing device 102 may further control the first display screen 114 to display the stored product information and the generated ownership information associated with the purchased first product 112A. For example, the stored product information and the generated ownership information may be displayed through a user-interface of the ownership management software associated with the first computing device 102. The product ownership management is described further, for example, in FIGS. 3A, 3B 4, 5, 6, and 7. An example of the user-interface of the ownership management software is described further, for example, in FIG. 8.

The disclosed first computing device 102 may dynamically receive the product information associated with the purchased first product 112A, when the determined first geo-location matches the second geo-location associated with the purchase of the first product 112A. If the first geo-location and the second geo-location matches, this may indicate that the first user 120 may be physically present at a location of the retail store 108 at the time of the purchase of the first product 112A. Thus, the matching of the first geo-location and the second geo-location may ensure that the purchase of the first product 112A may be legitimate by the first user 120 and that the product information may be received for such genuine product purchase transaction. Also, the ownership management software may automatically generate the ownership information related to the first product 112A based on the received product information. The automatic reception of the product information and generation of the ownership information may eliminate a need for the first user 120 (or for a person associated with the retail store 108) to manually enter (or scan) a product identification number (such as, a serial number or other product information) of the purchased first product 112A into the ownership management software, and later manage the purchased first product 112A based on the product information automatically added in the ownership management software of the first computing device 102. Based on the automatic addition of the product information and generation of the ownership information on the first computing device 102 (say via the ownership management software), the purchased first product 112A may be automatically registered on the ownership management software (or other applications) of the first computing device 102. The automatic entry of the product information of the purchased first product 112A may be less prone to errors than manual data input and may also be less time consuming. In an embodiment, an ownership of the purchased first product 112A may be managed through the ownership management software. For example, the first product 112A may be rented, exchanged, or sold by use of the ownership management software, based on the product information and the ownership information associated with the purchased first product 112A. Thus, the ownership of the purchased first product 112A may be effectively managed through the ownership management software/application installed on the first computing device 102.

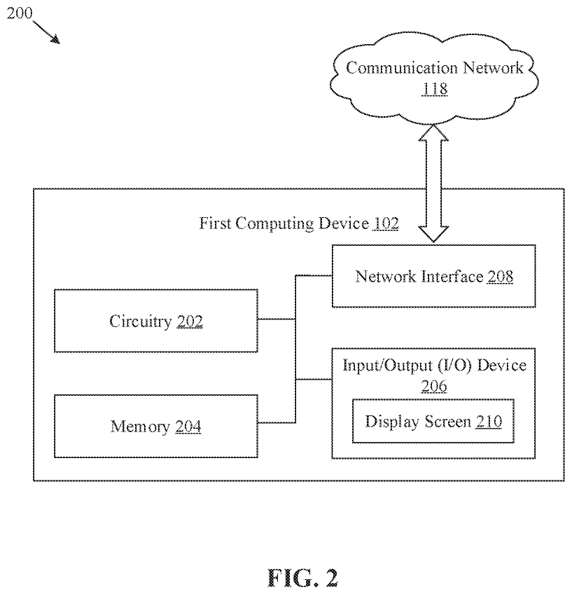

FIG. 2 is a block diagram that illustrates an exemplary first computing device for product ownership management, in accordance with an embodiment of the disclosure. FIG. 2 is explained in conjunction with elements from FIG. 1. With reference to FIG. 2, there is shown a block diagram 200 of the first computing device 102. The first computing device 102 may include circuitry 202, memory 204, an input/output (I/O) device 206, and a network interface 208. The I/O device 206 may further include a display screen 210 as an exemplary implementation of the first display screen 114. Therefore, the description of the display screen 210 is omitted from the disclosure for the sake of brevity. The network interface 208 may connect the first computing device 102 with the store management system 106 and the second computing device 104, via the communication network 118.

The circuitry 202 may include suitable logic, circuitry, and interfaces that may execute program instructions associated with different operations to be executed by the first computing device 102. For example, some of the operations may include determination of the first geo-location, reception of the credit information, comparison of the first geo-location and the second geo-location, reception of the product information, storage of the product information, generation of ownership information, and control of the display screen 210. The circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The circuitry 202 may be implemented based on a number of processor technologies known in the art. Examples of the processor technologies may include, but are not limited to, a Central Processing Unit (CPU), an x86-based processor, a Reduced Instruction Set Computing (RISC) processor, an Application-Specific Integrated Circuit (ASIC) processor, a Complex Instruction Set Computing (CISC) processor, a Graphical Processing Unit (GPU), a co-processor, or a combination thereof.

The memory 204 may include suitable logic, circuitry, and/or interfaces that may store a set of one or more instructions to be executed by the circuitry 202. The memory 204 may store operating systems and associated applications. The memory 204 may store the ownership management software/application. In accordance with an embodiment, the memory 204 may further store, but not limited to, the product information associated with the purchased first product 112A, the credit information associated with the purchased first product 112A, or the ownership information. The memory 204 may further store the first geo-location and the second geo-location for comparison by the circuitry 202. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may receive an input from a user (such as the first user 120), and provide an output based on the received input. The I/O device 206 may include various input and output devices, which may communicate with the circuitry 202. For example, the first computing device 102 may receive (via the I/O device 206) a user input indicative of a first operation with an update of an ownership of the purchased first product 112A. Examples of the I/O device 206 may include, but are not limited to, a touch screen, a keyboard, a mouse, a joystick, a display device (for example, the display screen 210), a microphone, or a speaker.

The network interface 208 may include suitable logic, circuitry, code, and/or interfaces that may facilitate communication between the first computing device 102, and the store management system 106, via the communication network 118. The network interface 208 may be implemented by use of various known technologies to support wired or wireless communication of the first computing device 102 with the communication network 118. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may communicate via wireless communication with networks, such as the Internet, an Intranet, a wireless network, a cellular telephone network, a wireless local area network (LAN), or a metropolitan area network (MAN). The wireless communication may use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The operations of the circuitry 202 are described, for example, in FIGS. 3A, 3B, 4, 5, 6, 7, and 8. It may be noted that the first computing device 102 shown in FIG. 2 may include various other components or systems. The description of the other components or systems of the first computing device 102 has been omitted from the disclosure for the sake of brevity.

FIGS. 3A and 3B, collectively, illustrate an exemplary processing pipeline for product ownership management on a first computing device, in accordance with an embodiment of the disclosure. FIGS. 3A and 3B are explained in conjunction with elements from FIG. 1 and FIG. 2. With reference to FIGS. 3A and 3B, there is shown a processing pipeline 300 of operations from 302 to 318 to depict product ownership management. The operations 302 to 318 of the processing pipeline 300 may be executed by any computing system, such as by the first computing device 102 of FIG. 1 or the circuitry 202 of FIG. 2.

At 302, a first geo-location may be determined. In an embodiment, the circuitry 202 may be configured to determine the first geo-location associated with the first computing device 102. The first geo-location associated with the first computing device 102 may correspond to a current geo-location where the first computing device 102 may be present and/or in use. In an embodiment, the first computing device 102 may receive a user input (for example, via the I/O device 206) indicative of the geo-location of the first computing device 102.

In an embodiment, the first computing device 102 may include one or more sensors such as location sensor (not shown) to determine the first geo-location. The location sensor may include suitable logic, circuitry, code and/or interfaces that may determine a current geo-location of the first computing device 102. An example of the location sensor may include, but are not limited to, a Global Navigation Satellite System (GNSS)-based sensor of the first computing device 102. Examples of the GNSS-based sensor may include, but are not limited to, global positioning sensor (GPS), Global Navigation Satellite System (GLONASS), or other regional navigation systems and/or sensors. A person with ordinary skill in the art will understand that the scope of the present disclosure may not be limited to the implementation of the location sensor incorporated in its entirety or at least partially in the first computing device 102. In certain embodiments, the location sensor and the first computing device 102 may be implemented as two separate entities, without a departure from the scope of the present disclosure.

In an embodiment, the first geo-location may be determined based on the at least one of Global Positioning System (GPS) information or an Internet Protocol (IP) address associated with the first computing device 102. The first computing device 102 may include an integrated location sensor, for example, a Global Positioning System (GPS) sensor, that may determine geo-location information such as, but not limited to, a latitude, a longitude, and an altitude associated with the first geo-location. The first computing device 102 may automatically determine the first geo-location associated with the first computing device 102 based on the geo-location information captured by the GPS sensor. In some embodiments, the first computing device 102 may automatically determine the first geo-location based on the IP address associated with the first computing device 102.

At 304, credit information may be received. In an embodiment, the circuitry 202 may be configured to receive the credit information from the store management system 106 associated with the retail store 108. The credit information may be associated with a purchase of a first product (such as the first product 112A) by a first user (such as the first user 120) of the first computing device 102. The first product 112A may be purchased by the first user 120 from the retail store 108 which is associated with the store management system 106. In an embodiment, the first product 112A may be purchased by the first user 120 by physically visiting a location of the retail store 108. The received credit information may include a second geo-location associated with the purchase of the first product 112A. The second geo-location may be a location of the retail store 108 from where the first product 112A is purchased. Based on the purchase, the store management system 106 may receive the credit information associated with the purchase of the first product 112A from the database 110. The store management system 106 may further transmit the received credit information associated with the purchase of the first product 112A to the first computing device 102. As an example, the received credit information 320 is shown in FIG. 3A. The credit information 320 may include, but is not limited to, the second geo-location 320A, a date and time of purchase 320B of the purchase of the first product 112A, a mode of payment for purchase 320C of the first product 112A, and an invoice details 320D associated with the purchase of the first product 112A.

In an embodiment, the second geo-location 320A may be determined based on the at least one of Global Positioning System (GPS) information or an Internet Protocol (IP) address associated with the store management system 106 or with the retail store 108. In another embodiment, the second geo-location 320A may be determined based on a user input received by the store management system 106. The user input may be provided by an administrator associated with the store management system 106 or an employee of the retail store 108. The date and time of the purchase 320B may be related to a date and time at which the first user 120 purchased the first product 112A from the retail store 108. For example, the date and time of purchase 320B may indicate that the first product 112A may be purchased by the first user 120 from the retail store 108 on a certain day (e.g., Apr. 23, 2021) at certain time (e.g., 11:00 AM). The mode of payment for purchase 320C may be related to a payment mode employed by the first user 120 to purchase the first product 112A. For example, the mode of payment for purchase 320C may include at least one of a cash payment mode, or a cashless payment mode. For example, the mode of payment for purchase 320C may indicate that the first user 120 may have made the payment for the purchase of the first product 112A via a Debit Card, Credit Card, or a digital wallet. The invoice details 320D may be related to invoice details associated with the purchase of the first product 112A, for example, not limited to an invoice number, number of products, product information, a product name, and signature of authorized personnel, or warranty period.

At 306, the first geo-location and the second geo-location may be compared. In an embodiment, the circuitry 202 may be configured to compare the determined first geo-location and the second geo-location associated with the purchase of the first product 112A. The circuitry 202 may determine whether or not the determined first geo-location associated with the first computing device 102, and the second geo-location associated with the purchase of the first product 112A (or with the retail store 108) match. In case the first geo-location matches with the second geo-location, this may indicate that the first user 120 with the first computing device 102 may be physically present at a location of the retail store 108 at the time of the purchase of the first product 112A. If the determined first geo-location and the second geo-location associated with the purchase of the first product 112A matches, then control may pass to 308. Otherwise, the control may pass to end.

At 308, product information may be received. In an embodiment, the circuitry 202 may be configured to automatically receive the product information associated with the purchased first product 112A from the store management system 106, based on the comparison. The store management system 106 may receive the product information from the database 110. The store management system 106 may transmit the received product information to the first computing device 102. As an example, the received product information 322 is shown in FIG. 3A. The product information 322 may include, but is not limited to, a product identification number 322A, a product name 322B, a product license information 322C, a product usage terms 322D, and a warranty period 322E.

The product identification number 322A may be related to a unique identification number associated with the purchased first product 112A. For example, the product identification number 322A may indicate a unique identification number such as “1234” to identify the purchased first product 112A. The product name 322B may be related to a name of the purchased first product 112A. For example, the product name 322B may indicate a product name such as an “automobile” or a hatch-back car of a certain company, or a model name of the first product 112A. The product license information 322C may be related to an authorization document associated with the purchased first product 112A. For example, the product license information 322C may include a certificate of registration or ownership associated with the purchase of the first product 112A. The product usage terms 322D may be related to the terms and conditions associated with usage of the purchased first product 112A. For example, the product usage terms 322D may include terms such as, but not limited to, terms related to authorized parties, a privacy policy, a delivery and shipping terms, payment terms, an assembly/installation policy, a replacement policy, or liability terms. The warranty period 322E may be related to a time period for which the purchased first product 112A may be repaired or serviced for free. For example, the warranty period 322E may indicate a time period such as, but not limited to, 6 months or 1 year as warranty period provided by a manufacturer or retailer of the first product 112A.

At 310, the received product information may be stored. In an embodiment, the circuitry 202 may be configured to store the received product information associated with the purchased first product 112A. The received product information may be stored in the memory 204. The stored product information may then be accessible by the first user 120 via an ownership management software 324 associated with the first computing device 102. In an embodiment, prior to the storage of the received product information, the circuitry 202 may be configured to control the display screen 210 to display a notification to the first user 120 that may prompt the first user 120 to provide a confirmation associated with the storage of the received product information in the memory 204. Based on a user input received from the first user 120 in response to the notification, the received product information may be stored. For example, in case the user input (received via the I/O device 206) indicates that the product information is to be stored, the circuitry 202 may store the received product information in the memory 204 and control may pass to 312. Otherwise, control may pass to end. The receipt of the confirmation from the first user 120 for the storage and for the use of the product information on the first computing device 102 may ensure that privacy concerns of the first user 120 with respect to the purchase of the first product 112A are addressed.

At 312, ownership information may be generated. In an embodiment, the circuitry 202 may be configured to generate the ownership information of the purchased first product 112A via the ownership management software 324, based on the stored product information. The ownership management software 324 may retrieve the stored product information from the memory 204 and generate the ownership information associated with the purchased first product 112A. In an embodiment, the generated ownership information may be stored in a memory (such as the memory 204) associated with the first computing device 102. The generated ownership information may then be accessible by the first user 120 via the ownership management software 324. In an embodiment, the circuitry 202 may automatically generate the ownership information of the first product 112A. In another embodiment, the circuitry 202 may receive a user input indicative of the ownership information of the purchased first product 112A. The circuitry 202 may generate the ownership information of the purchased first product 112A based on the received user input.

As an example, the generated ownership information 326 is shown in FIG. 3A. The generated ownership information 326 may include, but is not limited to, information about an owner 326A of the purchased first product 112A, and a time interval associated with the ownership 326B of the purchased first product 112A. The owner 326A of the purchased first product 112A may be the first user 120 who may have purchased the first product 112A from the retail store 108. The information about the owner 326A may include, but is not limited to, an owner full name, a unique identification number of the owner, a contact details of the owner. The time interval associated with the ownership 326B of the purchased first product 112A may indicate a time period for which the purchased first product 112A may be owned or used by the owner (such as the first user 120). For example, the time interval associated with the ownership 326B may indicate a time interval of 6 months or 1 year for which the owner may have purchased or rented the first product 112A from the retail store 108. In another example, the time interval associated with the ownership 326B may be permanent or for a life time of the first product 112A or the first user 120. In an example, the ownership information 326 may be generated based on the product license information 322C indicated by the received product information. For example, the product license information 322C may include a certificate of registration or ownership associated with the purchase of the first product 112A. The ownership information 326 may be determined based on information related to the owner as per the certificate of registration or ownership.

At 314, a display screen (such as the display screen 210) may be controlled. In an embodiment, the circuitry 202 may be configured to control the display screen 210 to display the stored product information and the generated ownership information associated with the purchased first product 112A. The circuitry 202 may retrieve, from the memory 204, the stored product information and the generated ownership information and further control the display screen 210 to display the stored product information, and the generated ownership information.

At 316, a first product profile may be generated. In an embodiment, the circuitry 202 may be configured to generate, via the ownership management software 324, the first product profile associated with the purchased first product 112A. The first product profile may be generated based on the stored product information and the generated ownership information associated with the purchased first product 112A. The ownership management software 324 may retrieve, from the memory 204, the stored product information and the generated ownership information associated with the purchased first product 112A and further generate the first product profile associated with the purchased first product 112A. The first product profile associated with the purchased first product 112A may include, but is not limited to, the product information, the ownership information, and the credit information associated with the purchased first product 112A. For example, the first product profile may indicate which product is purchased (i.e. product details), who is current owner of the product, details of invoicing, details of retail store, details of payment, date-time of purchase, warranty and licensing details, etc.

At 318, information related to the generated first product profile may be transmitted. In an embodiment, the circuitry 202 may be configured to transmit the information related to the generated first product profile to a control device 328 of the purchased first product 112A. The control device 328 may store the information related to the generated first product profile. The control device 328 may include suitable logic, circuitry, interfaces, and/or code that may store the product profile associated with the purchased first product 112A. The control device 328 be associated with, inbuilt, or embedded within the first product 112A. For example, the control device 328 may be an in-built chip or a processing and communication device. The control device 328 may include a network interface through which the one or more products may communicate with the first computing device 102. The control device 328 may use different types of communication technologies, such as a short-range communication or a long-range communication. The short-range communication may be a point-to-point communication, a point-to-point line-of-sight (LOS) communication, or a point-to-multipoint communication. Examples of protocols for the short-range communication may include, but are not limited to, Radio Frequency Identification (RFID), Wireless USB, Dedicated Short Range Communications (DSRC), and Near Field Communication (NFC) (e.g., NFC Peer-to-Peer), Bluetooth, or Bluetooth Low Energy (BLE).

In an embodiment, the generated first product profile may be accessible by the first user 120 via the ownership management software 324. The circuitry 202 may store the information related to the generated first product profile in the memory 204. The circuitry 202 may control the display screen 210 to display the information related to the generated first product profile associated with the purchased first product 112A. The information related to the generated first product profile may be displayed through the user-interface of the ownership management software, via the display screen 210. The disclosed first computing device 102 may automatically generate the first product profile via the ownership management software 324. The first product profile may be used for ownership management of the purchased first product 112A. The automatic reception of the product information from the store management system 106, and automatic generation of the ownership information and the first product profile may eliminate manual inputs required from the first user 120, to add details related to the first product 112A in the first computing device 102 or in the ownership management software 324. Based on the automatic reception of the product information and generation of the ownership information on the first computing device 102 (say via the ownership management software 324), the purchased first product 112A may be automatically registered on the ownership management software (or other applications) of the first computing device 102. The elimination of need of the manual inputs may further reduce a likelihood of errors, time, and effort associated with manual inputs to enter details of the purchased products on the first computing device 102. Further, as the product information is received from the store management system 106 if a location (i.e., the first geo-location) of the first user 120 of the first computing device 102 matches with a location (i.e., the second geo-location) of the retail store 108, the purchase of the first product 112A may be considered as a valid transaction that occurred when the first user 120 was physically present at the retail store 108. This may enhance the credibility of the purchased first product 112A based on the generated ownership information, and further ensure that the first product 112A is not stolen or illegitimate.

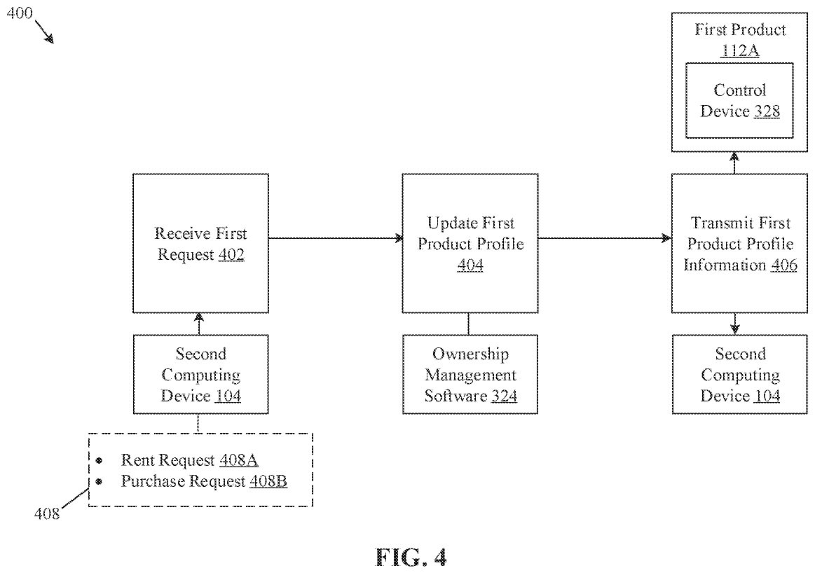

In an embodiment, the circuitry 202 may receive a first user input (for example via the ownership management software 324) indicative of a first operation associated with an update of an ownership of the purchased first product 112A. The first operation associated with the update of the ownership of the purchased first product 112A may include, but is not limited to, a rent operation, an exchange operation, or a sale operation associated with the purchased first product 112A. An example of the user-interface of the ownership management software is described further, for example, in FIG. 8. In an embodiment, the circuitry 202 may receive, via the display screen 210 (or the I/O device 206), the first user input indicative of the first operation. Based on the received first user input, the circuitry 202 may update, via the ownership management software 324, the ownership information associated with the purchased first product 112A. The update of the ownership information associated with the purchased first product 112A may include modification of the ownership information (such as the owner of the purchased first product 112A), based on the first operation associated with the purchased first product 112A. The update of the ownership information associated with the purchased first product 112A may further include addition or update of the information related to the generated first product profile and/or removal of the information related to the generated first product profile, via the ownership management software 324. The circuitry 202 may further control the display screen 210 to display the product information and the updated ownership information associated with the purchased first product 112A. The update of the first product profile via the ownership management software is described further, for example, in FIG. 4.

FIG. 4 illustrates an exemplary processing pipeline for update of product profile via an ownership management software associated with a first computing device, in accordance with an embodiment of the disclosure. FIG. 4 is explained in conjunction with elements from FIGS. 1, 2, 3A, and 3B. With reference to FIG. 4, there is shown a processing pipeline 400 of operations from 402 to 406 to depict update of a product profile via an ownership management software (such as the ownership management software 324). The operations 402 to 406 of the processing pipeline 400 may be executed by any computing system, such as by the first computing device 102 of FIG. 1 or the circuitry 202 of FIG. 2.

At 402, a first request may be received. In an embodiment, the circuitry 202 may be configured to receive the first request from a second computing device (such as the second computing device 104) of a second user (such as the second user 122). The first request may be associated with an ownership of the purchased first product 112A. The first request may be received as a user input through the second display screen 116 (or an I/O device, similar to the I/O device 206) associated with the second computing device 104. In an example, the second computing device 104 associated with the second user 122 may transmit a request 408 such as, a rent request 408A, or a purchase request 408B associated with the purchased first product 112A to the first computing device 102. The rent request 408A may be sent by the second user 122 through the second computing device 104, to rent the first product 112A from the first user 120 for a particular time period. The purchase request 408B may be sent by the second user 122 through the second computing device 104, to purchase or buy the first product 112A from the first user 120. Though not shown in FIG. 4, in an example, the request 408 may be an exchange request.

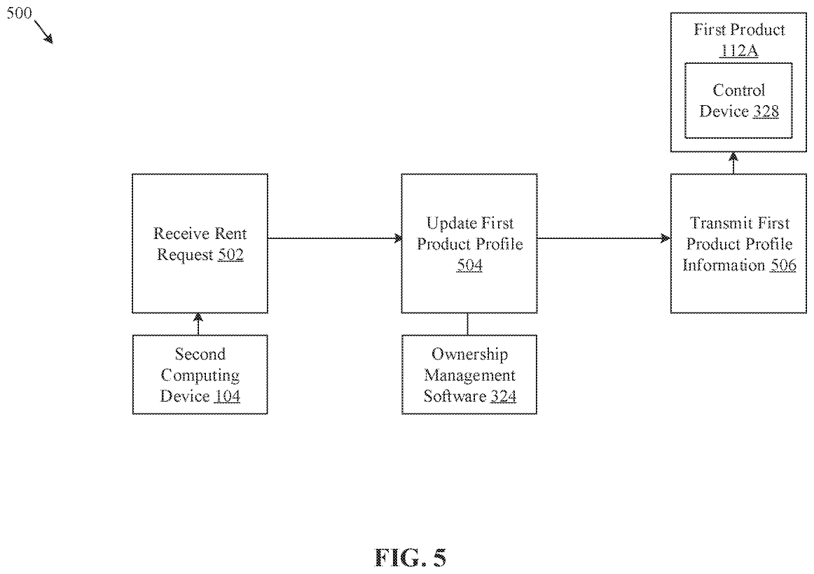

At 404, the first product profile may be updated. In an embodiment, the circuitry 202 may be configured to update, via the ownership management software 324, the first product profile associated with the purchased first product 112A based on the received first request. The circuitry 202 may update the first product profile via the ownership management software 324 associated with the first computing device 102. The update of the first product profile may indicate an update of the ownership information associated with the purchased first product 112A based on the received first request from the second computing device 104. In other words, the update of the first product profile may include, but is not limited to, a modification of the ownership information (such as, the owner) associated with the purchased first product 112A based on the received first request from the second computing device 104. The update of the first product profile for different types of requests (like rent, purchase, and exchange) is further described, for example, in FIGS. 5, 6, and 7, respectively.

At 406, the information related to the updated first product profile may be transmitted. In an embodiment, the circuitry 202 may be configured to transmit the information related to the updated first product profile to the second computing device 104. The circuitry 202 may transmit, via the ownership management software 324, the information related to the updated first product profile (i.e. associated with the purchased first product 112A) to the second computing device 104. The ownership management software 324 may retrieve the information related to the updated first product profile from the memory 204 of the first computing device 102, and the transmit the information related to the updated first product profile to the second computing device 104. The updated first product profile may indicate a change in the owner for the first product 112A, for example, from the first user 120 to the second user 122.

In an embodiment, the circuitry 202 may transmit the information related to the updated first product profile to the control device 328 associated with or attached to the purchased first product 112A. The control device 328 may store the information related to the updated first product profile. Details of the transmission of the information related to the first product profile to the control device 328 is described, for example, at 318, in FIG. 3B.

FIG. 5 illustrates an exemplary processing pipeline for update of product profile via an ownership management software associated with a first computing device, in accordance with an embodiment of the disclosure. FIG. 5 is explained in conjunction with elements from FIGS. 1, 2, 3A, 3B and 4. With reference to FIG. 5, there is shown a processing pipeline 500 of operations from 502 to 506 to depict update of product profile via an ownership management software (such as the ownership management software 324). The operations 502 to 506 of the processing pipeline 500 may be executed by any computing system, such as by the first computing device 102 of FIG. 1 or the circuitry 202 of FIG. 2.

At 502, a rent request may be received. In an embodiment, the circuitry 202 may be configured to receive a first request from a second computing device (such as the second computing device 104) of a second user (such as the second user 122). The first request may be associated with an ownership of the purchased first product 112A. The first request may be a request by the second user 122 to rent the purchased first product 112A. The first request may be received as described, for example, at 402 in FIG. 4.

In an embodiment, the first request (i.e. rent request) may include information about a first time period for which the purchased first product 112A is to be rented to the second user 122 associated with the second computing device 104. In an embodiment, the second computing device 104 may receive, via the second display screen 116 (or an I/O device, similar to the I/O device 206), a user input indicative of the first time period from the second user 122. The circuitry 202 may determine the first time period based on the user input included in the received first request. In another embodiment, the second computing device 104 may set a pre-defined time period as a default first time period, which may be stored in a memory of the second computing device 104 (similar to the memory 204 shown in FIG. 2). The circuitry 202 of the first computing device 102 may be further configured to update (as described at 404 in FIG. 4) the first product profile based on the received rent request from the second computing device 104. The update of the first product profile may indicate an update of the ownership information associated with the purchased first product 112A based on the received rent request from the second computing device 104. In other words, the update of the first product profile may include, but is not limited to, a modification of the ownership information (such as, the owner) associated with the purchased first product 112A based on the received rent request from the second computing device 104. In the modification, the owner of the first product 112A may be updated to the second user 122 for the first time period associated with the rent request. In some embodiments, the modification of the ownership information may correspond to an indication in the ownership information, that the first product 112A may be rented by the second user 122 for the first time period. The update of the first product profile may further include an update of the time period associated with the first product profile to the first time period associated with the rent request of the first product 112A initiated by the second user 122 of the second computing device 104. The circuitry 202 may be further configured to transmit (as described at 406 in FIG. 4) the updated first product profile to the second computing device 104 and the control device 328. The second computing device 104 and control device 328 may further store the received information about the updated first product profile.

At 504, the first product profile may be updated. In an embodiment, the circuitry 202 may be configured to update, via the ownership management software 324, the first product profile based on an expiry of the first time period from the receipt of the first request (i.e. rent request). The expiry of the first time period may indicate that a duration of renting the first product 112A to the second user 122 has expired and the first product 112A is not rented to the second user 122 and should be returned to the first user 120 (i.e. actual owner of the first product 112A). In such case, the information about the first product profile may be deleted from the second computing device 104 based on the expiry of the first time period. In some embodiments, the first computing device 102 may send a notification or a command to the second computing device 104 to delete the stored information about the first product profile. In an embodiment, the circuitry 202 of the first computing device 102 may further update the information about the first product profile based on a passage of the first time period from the receipt of the first request. For example, when the received first request is a request to rent the purchased first product 112A, the circuitry 202 may update the ownership information, such as the time interval associated with the ownership may indicate a time (such as, but not limited to 15 days, 1 month, or 1 year) for which the purchased first product 112A may be rented by the second user 122 associated with the second computing device 104. Thereafter, the circuitry 202 may update ownership information in the first product profile as ‘rented’ on the first computing device 102, and transmit the information about the first product profile to the second computing device 104 for the first time period for which the purchased first product 112A is rented to the second user 122. Upon completion of the first time period, the circuitry 202 may control the second computing device 104 to delete the information about the first product profile from the second computing device 104, and update the information about the first product profile as ‘available’ on the first computing device 102.

In an embodiment, the circuitry 202 may update, via the ownership management software 324, the first product profile for both the first computing device 102, and the second computing device 104. In another embodiment, the circuitry 202 may update, via the ownership management software 324, the information about the first product profile for the first computing device 102, and delete the stored information about the first product profile on the second computing device 104, via an ownership management software associated with the second computing device 104.

At 506, the information related to the updated first product profile may be transmitted. In an embodiment, the circuitry 202 may be configured to transmit the information related to the updated first product profile (i.e. stored on the first computing device 102) to the control device 328 associated with or attached to the purchased first product 112A. The control device 328 may further store the information related to the updated first product profile. Details of the transmission of the information related to the first product profile is described, for example at 318, in FIG. 3B.

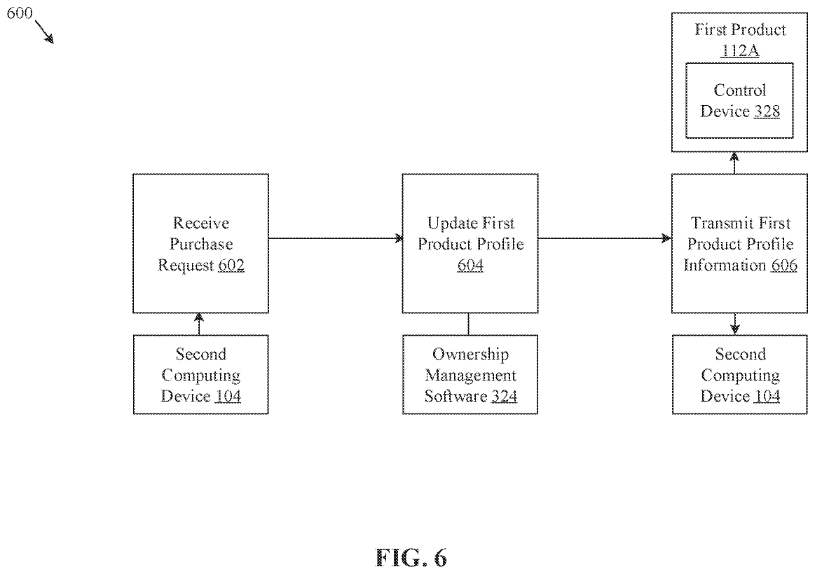

FIG. 6 illustrate an exemplary processing pipeline for update of product profile via an ownership management software associated with a first computing device, in accordance with an embodiment of the disclosure. FIG. 6 is explained in conjunction with elements from FIGS. 1, 2, 3A, 3B, 4, and 5. With reference to FIG. 6, there is shown a processing pipeline 600 of operations from 602 to 606 to depict update of product profile via an ownership management software (such as the ownership management software 324). The operations 602 to 606 of the processing pipeline 600 may be executed by any computing system, such as by the first computing device 102 of FIG. 1 or the circuitry 202 of FIG. 2.

At 602, a purchase request may be received. In an embodiment, the circuitry 202 may be configured to receive a first request from a second computing device (such as the second computing device 104) of a second user (such as the second user 122). The first request may be associated with an ownership of the purchased first product 112A. The first request may be a request of the second user 122 to purchase the first product 112A from the first user 120. The first request may be received as described, for example, at 402 in FIG. 4.

At 604, the first product profile may be updated. In an embodiment, the circuitry 202 may update, via the ownership management software 324, the information about the first product profile based on the received first request from the second computing device 104. The update of the information about the first product profile may include a deletion of the generated first product profile from the first computing device 102, and a transmission of the information related to the first product profile to the second computing device 104. In an embodiment, the circuitry 202 may delete the generated information about the first product profile from the first computing device 102 based on the received purchase request from the second computing device 104. For example, when the received first request is a request of the second user 122 to purchase the first product 112A from the first user 120, the circuitry 202 may update the ownership information as the owner of the first product 112A may change from the first user 120 to the second user 122. Thereafter, the circuitry 202 may delete the information about the first product profile from the first computing device 102.

At 606, the information related to the updated first product profile may be transmitted. In an embodiment, the circuitry 202 may transmit the information related to the updated first product profile to the second computing device 104 of the second user 122 and to the control device 328 associated with or attached to the purchased first product 112A. The second computing device 104 and the control device 328 may further store the information related to the updated first product profile. The updated information may indicate a new owner of the first product 112A as the second user 122. Details of the transmission of the information related to the first product profile is described, for example at 318 in FIGS. 3A, and 3B.

In an embodiment, the circuitry 202 may transmit the information related to the first product profile to the second computing device 104, via the ownership management software 324. Thereafter, an ownership management software (not shown) associated with the second computing device 104, may receive the information related to the first product profile and may further store the received information in the memory (i.e. similar to the memory 204) of the second computing device 104. The second computing device 104 may further control the second display screen 116 (or an I/O device, similar to the I/O device 206) to display the received information (i.e. related to the first product profile) to the second user 122.

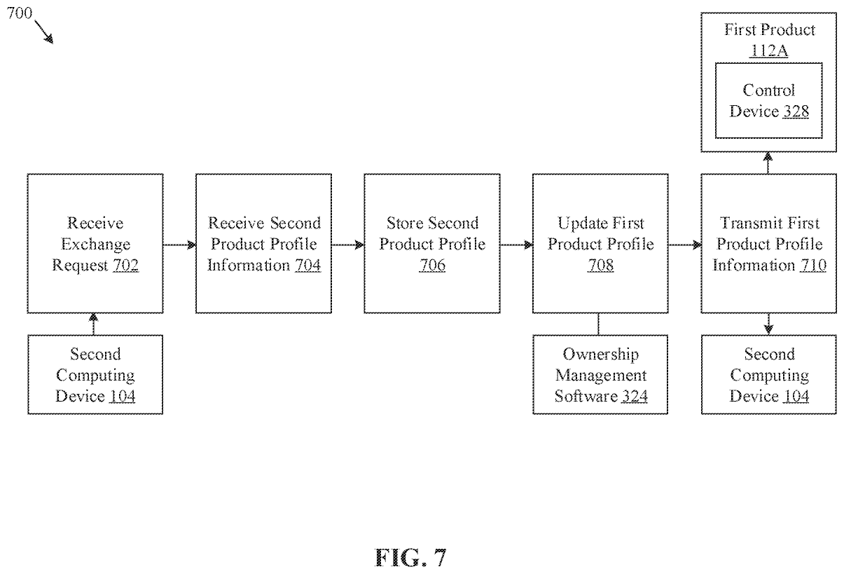

FIG. 7 illustrate an exemplary processing pipeline for update of product profile via an ownership management software associated with a first computing device, in accordance with an embodiment of the disclosure. FIG. 7 is explained in conjunction with elements from FIGS. 1, 2, 3A, 3B, 4, 5, and 6. With reference to FIG. 7, there is shown a processing pipeline 700 of operations from 702 to 710 to depict update of product profile via an ownership management software (such as the ownership management software 324). The operations 702 to 710 of the processing pipeline 700 may be executed by any computing system, such as by the first computing device 102 of FIG. 1 or the circuitry 202 of FIG. 2.

At 702, an exchange request may be received. In an embodiment, the circuitry 202 may be configured to receive a second request from a second computing device (such as the second computing device 104) of a second user (such as the second user 122). The second request may be associated with an exchange of the purchased first product 112A owned by the first user 120 with a second product (such as the second product 112B) owned by the second user 122. The second request may be received from the second user 122 as a user input through the second display screen 116 (or an I/O device, similar to the I/O device 206) associated with the second computing device 104. In an example, the second computing device 104 associated with the second user 122 may transmit a second request to the first computing device 102, for exchange of the purchased first product 112A owned by the first user 120 with the second product 112B owned by the second user 122.

At 704, a second product profile may be received. In an embodiment, the circuitry 202 of the first computing device 102 may receive, from the second computing device 104, information about the second product profile associated with the second product 1128. The circuitry 202 may receive, via the ownership management software 324, the information about the second product profile associated with the purchased second product 112B. The second product profile associated with the second product 112B purchased by the second user 122 may be similar to the first product profile associated with the first product 112A purchased by the first user 120, however the ownership information of the second product profile may indicate that the owner of the second product 1128 is the second user 122. The second product profile may be generated via an ownership management software (not shown) associated with the second computing device 104. The ownership management software associated with the second computing device 104, may transmit the information related to the second product profile to the first computing device 102 for the exchange. The second product profile may be generated based on pre-stored product information and generated ownership information associated with the second product 112B purchased by the second user 122 on the second computing device 104. The information related to the second product profile may be stored in the memory (i.e. similar to the memory 204) associated with the second computing device 104. The information related to the second product profile may be further transmitted to a control device (not shown) of the second product 112B. In an embodiment, prior to the transmission of the information about the second product profile to the first computing device 102, the second computing device 104 may be configured to update the second product profile, via the ownership management software associated with the second computing device 104. For example, via the ownership management software associated with the second computing device 104, an owner associated with the second product 1126 may be updated from the second user 122 to the first user 120. The second computing device 104 may be further configured to transmit the information related to the updated second product profile to the control device of the second product 1126 for storage at the control device.

At 706, the information related to the second product profile may be stored. In an embodiment, the circuitry 202 of the first computing device 102 may store the received information related to the second product profile (i.e. associated with the second product 112B) in the memory 204. The circuitry 202 may further control the display screen 210 of the first computing device 102 to display the information related to the second product profile (i.e. associated with the second product 1126) to the first user 120. The displayed information may notify the first user 120 that the second product 1126 is now exchanged and owned by the first user 120 of the first computing device 102.

At 708, the first product profile may be updated. In an embodiment, the circuitry 202 may update, via the ownership management software 324, the information about the first product profile associated with the purchased first product 112A based on the received second request. For example, the circuitry 202 may update, via the ownership management software 324, the first product profile associated with the purchased first product 112A to update the owner of the purchased first product 112A from the first user 120 to the second user 122.

In an embodiment, the circuitry 202 may update both the first product profile and the second product profile, through the ownership management software 324, for both the first computing device 102 and the second computing device 104. In such case, as the second product profile may be updated by the first computing device 102, the second computing device 104 may not update the second product profile prior to the transmission of the second product profile to the first computing device 102, as described, for example, at 704.

At 710, the information related to the updated first product profile may be transmitted. In an embodiment, the circuitry 202 may transmit the information related to the updated first product profile to the control device 328 associated with or attached to the purchased first product 112A. The control device 328 may store the information related to the updated first product profile. The updated information about the first product profile stored in the control device 328 may indicate that the current owner of the first product 112A is the second user 122 based on the exchange performed at 702 in FIG. 7. Details of the transmission of the information related to the first product profile to the control device 328 is described, for example, at 318 in FIG. 3B.

In an embodiment, the circuitry 202 may further transmit the information related to the first product profile to the second computing device 104. The second computing device 104 may store the information related to the received first product profile, for example, in a memory associated with the second computing device 104. The circuitry 202 may transmit the information related to the first product profile, via the ownership management software 324, to the second computing device 104. Thereafter, the ownership management software associated with the second computing device 104 may receive the information related to the first product profile. The second computing device 104 may further control the second display screen 116 to display the information related to the first product profile. The displayed information about the first product profile may notify the second user 122 that the first product 112A belongs to the second user 122 after the exchange, and also include the information (like product information) about the first product 112A for the second user 122. Thus, the disclosed first computing device 102 may allow different operations (like the rent operation, the purchase operation, and the exchange operation as described, for example, in FIGS. 5, 6, and 7, respectively) with the purchased first product 112A via the ownership management software 324 (or related application) installed on the first computing device 102, and automatically update the ownership information (or the product profile) based on the different operations.

FIG. 8 is a diagram that illustrates an exemplary scenario for product ownership management on a first computing device, in accordance with an embodiment of the disclosure. FIG. 8 is explained in conjunction with elements from FIGS. 1, 2, 3A, 3B 4, 5, 6, and 7. With reference to FIG. 8, there is shown an exemplary scenario 800. The scenario 800 may include a first computing device 802 as an exemplary implementation of the first computing device 102 of FIG. 1. The first computing device 802 may include a display screen 804 as an exemplary implementation of the first display screen 114 of FIG. 1. Therefore, the descriptions of the first computing device 802 and the display screen 804 are omitted from the disclosure for the sake of brevity. The display screen 804 may display a user interface (UI) of the ownership management software 324. The user interface (UI) may include a plurality of user interface (UI) elements that may correspond to user-selectable options.

It may be noted that, the first computing device 802 shown in FIG. 8 is presented merely as an example. The present disclosure may be also applicable to other types of the first computing device 802, for example a mobile phone, a monitor, a tablet, and other devices that may have a capability to perform the same features as described and illustrated for the first computing device 102, in addition to any other features. A description of other types of devices having at least similar functionalities as the first computing device 102 is omitted from the disclosure for the sake of brevity.

In the display screen 804, there is shown a first user interface (UI) element 806, and a second user interface (UI) element 808, through which an input may be accepted from the first user 120. For example, the first user interface (UI) element 806 may correspond to selection box. The first user interface (UI) element 806 may receive a first user input indicative (or selection) of a first operation associated with an update of an ownership of the purchased first product 112A. The first operation associated with the update of the ownership of the purchased first product 112A may include, but is not limited to, a rent operation, an exchange operation, a sale operation, or a purchase operation associated with the purchased first product 112A. As shown, for example, in FIG. 8. The first user input may select the exchange operation to exchange the first product 112A with the second user 122 of the second computing device 104 as described, for example, in FIG. 7.

In an embodiment, the second user interface (UI) element 808 may be, for example, a button (such as an Update button) that may receive a user confirmation input to update the ownership information associated with the purchased first product 112A based on the received first user input. The circuitry 202 may update, via the ownership management software 324, the ownership information associated with the purchased first product 112A, based on the received first user input. The update of the ownership information for different types of operations/requests (like rent, purchase, and exchange) is described, for example, in FIGS. 4, 5, 6, and 7. It should be noted that the scenario 800 is for exemplary purpose and should not be construed as limiting for the present disclosure.

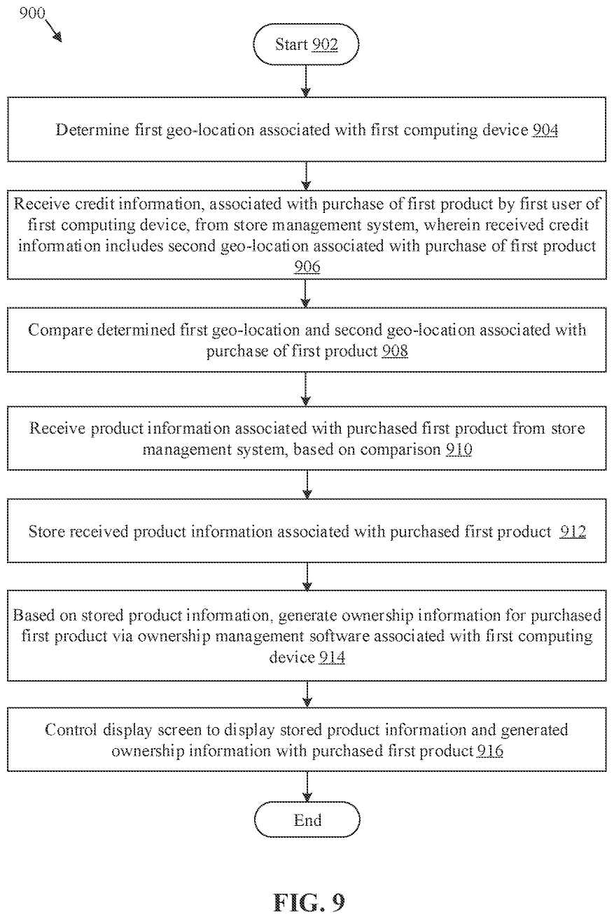

FIG. 9 is a flowchart that illustrates an exemplary method for product ownership management on a first computing device, in accordance with an embodiment of the disclosure. With reference to FIG. 9, there is shown a flowchart 900. The flowchart 900 is described in conjunction with FIGS. 1, 2, 3A, 3B, 4, 5, 6, 7, and 8. The operations from 904 to 916 may be implemented by the first computing device 102 shown in FIG. 1, or the circuitry 202 shown in FIG. 2. The operations of the flowchart 900 may start at 902 and proceed to 904.

At 904, a first geo-location may be determined. In an embodiment, the circuitry 202 may be configured to determine the first geo-location associated with the first computing device 102. The first geo-location may be determined based on at least one of Global Positioning System (GPS) information or an Internet Protocol (IP) address associated with the first computing device 102. The determination of the first geo-location is described, for example, at 302 in FIG. 3A.

At 906, credit information (such as the credit information 320) may be received. In an embodiment, the circuitry 202 may be configured to receive the credit information 320 that may be associated with a purchase of a first product (such as the first product 112A) by a first user (such as the first user 120). The credit information 320 may be received from the store management system 106 of the retail store 108. The first product 112A may be purchased from the retail store 108. The received credit information 320 may include a second geo-location (such as the second geo-location 320A) associated with the purchase of the first product 112A or associated with the retail store 108. The credit information 320 may further include, but is not limited to, a date and time of the purchase (such as the date and time of purchase 320B) of the first product 112A, a mode of payment for the purchase (such as the mode of payment for purchase 320C) of the first product 112A, or invoice details (such as the invoice details 320D) associated with the purchase of the first product 112A. The receipt of the credit information 320 is described, for example, at 304 in FIG. 3A.

At 908, the determined first geo-location and the second geo-location may be compared. In an embodiment, the circuitry 202 may be configured to compare the determined first geo-location of the first computing device 102 and the second geo-location associated with the purchase of the first product 112A at the retail store 108, as described further, for example, at 306 in FIG. 3A.

At 910, product information (such as the product information 322) associated with the purchased first product 112A may be received. In an embodiment, the circuitry 202 may be configured to receive the product information 322 associated with the purchased first product 112A from the store management system 106, based on the comparison. The product information 322 associated with the purchased first product 112A may include, but is not limited to, a product identification number (such as the product identification number 322A), a product name (such as the product name 322B), product license information (such as the product license information 322C), product usage terms (such as the product usage terms 322D), or a warranty period (such as the warranty period 322E) associated with the purchased first product 112A. The receipt of the product information 322 is described, for example, at 308 in FIG. 3A.

At 912, the product information 322 associated with the purchased first product 112A may be stored. In an embodiment, the circuitry 202 may be configured to store the received product information 322 associated with the purchased first product 112A in the memory 204, as described, for example, at 310 in FIG. 3A.

At 914, ownership information (such as the ownership information 326) associated with the purchased first product 112A may be generated. In an embodiment, the circuitry 202 may be configured to generate the ownership information 326 associated with the purchased first product 112A based on the stored product information 322. The ownership information 326 may be generated via an ownership management software (such as the ownership management software 324) associated with the first computing device 102. The ownership information 326 may indicate, but is not limited to, information about an owner (such as the owner 326A) of the purchased first product 112A and a time interval associated with the ownership (such as the time interval associated with ownership 326B) of the purchased first product 112A. The generation of ownership information 326 is described, for example, at 312 in FIG. 3A.

At 916, a display screen (such as the display screen 210) may be controlled. In an embodiment, the circuitry 202 may be configured to control the display screen 210 to display the stored product information 322 and the generated ownership information 326 associated with the purchased first product 112A. The display of the product information 322 and the ownership information 326, is described, for example, at 314 in FIG. 3B. Control passes to end.

Although the flowchart 900 is illustrated as discrete operations, such as 904, 906, 908, 910, 912, 914, and 916, the disclosure may not be so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (such as, the first computing device 102) communicatively coupled to a store management system (such as the store management system 106) of a retail store (such as the retail store 108). The set of instructions may be executable by the machine and/or the computer to perform the operations that may include determination of a first geo-location associated with the first computing device 102. The operations may further include reception of credit information (such as the credit information 320), associated with a purchase of a first product (such as the first product 112A) by a first user (such as the first user 120) of the first computing device 102, from the store management system 106. The received credit information 320 may include a second geo-location (such as the second geo-location 320A) associated with the purchase of the first product 112A. The operations may further include comparison of the determined first geo-location and the second geo-location 320A associated with the purchase of the first product 112A. The operations may further include reception of product information (such as the product information 322) associated with the purchased first product 112A from the store management system 106, based on the comparison. The operations may further include storage of the received product information 322 associated with the purchased first product 112A. The operations may further include, based on the stored product information 322, generation of ownership information (such as the ownership information 326) associated with the purchased first product 112A via an ownership management software (such as the ownership management software 324) associated with the first computing device 102. The operations may further include control of a display screen (such as the display screen 210) to display of the stored product information 322 and the generated ownership information 326 associated with the purchased first product 112A.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

What is claimed is:

1. A first computing device, comprising:
circuitry communicatively coupled to a store management system of a retail store, wherein the circuitry:
determines a first geo-location associated with the first computing device;
receives credit information, associated with a purchase of a first product by a first user of the first computing device, from the store management system, wherein the received credit information comprises a second geo-location associated with the purchase of the first product;
compares the determined first geo-location and the second geo-location associated with the purchase of the first product;
receives product information associated with the purchased first product from the store management system, based on the comparison;
stores the received product information associated with the purchased first product;
based on the stored product information, generates ownership information for the purchased first product via an ownership management software associated with the first computing device; and
controls a display screen to display the stored product information and the generated ownership information associated with the purchased first product.

2. The first computing device according to claim 1, wherein the first geo-location is determined based on at least one of Global Positioning System (GPS) information or an Internet Protocol (IP) address associated with the first computing device.

3. The first computing device according to claim 1, wherein the credit information comprises at least one of: a date and time of the purchase of the first product, a mode of payment for the purchase of the first product, or invoice details associated with the purchase of the first product.

4. The first computing device according to claim 1, wherein the product information associated with the purchased first product comprises at least one of: a product identification number, a product name, product license information, product usage terms, or a warranty period associated with the purchased first product.

5. The first computing device according to claim 1, wherein the generated ownership information indicates at least one of: an owner of the purchased first product and a time interval associated with the ownership of the purchased first product.

6. The first computing device according to claim 1, wherein the circuitry further:
receives a first user input indicative of a first operation associated with an update of an ownership of the purchased first product;
updates, via the ownership management software, the ownership information associated with the purchased first product based on the received first user input; and
controls the display screen to display the product information and the updated ownership information associated with the purchased first product.

7. The first computing device according to claim 6, wherein the first operation associated with the update of the ownership of the purchased first product comprises at least one of: a rent operation, an exchange operation, or a sale operation associated with the purchased first product.

8. The first computing device according to claim 1, wherein the circuitry further generates, via the ownership management software, a first product profile associated with the purchased first product based on the stored product information and the generated ownership information associated with the purchased first product.

9. The first computing device according to claim 8, wherein the circuitry further transmits information related to the generated first product profile to a control device of the purchased first product, and wherein the control device stores the information related to the generated first product profile.

10. The first computing device according to claim 8, wherein the circuitry further:
receives, from a second computing device of a second user, a first request associated with an ownership of the purchased first product;
updates, via the ownership management software, the first product profile associated with the purchased first product based on the received first request;
transmits information related to the updated first product profile to the second computing device; and
transmits the information related to the updated first product profile to a control device of the purchased first product.

11. The first computing device according to claim 10, wherein the update of the first product profile indicates an update of the ownership information associated with the purchased first product based on the received first request from the second computing device.

12. The first computing device according to claim 10, wherein the first request is a request to rent the purchased first product to the second user, and wherein the ownership information includes a first time period for which the purchased first product is to be rented to the second user associated with the second computing device.

13. The first computing device according to claim 12, wherein the circuitry further
updates, via the ownership management software, the first product profile based on an expiry of the first time period from the receipt of the first request, wherein the first product profile is deleted from the second computing device based on the expiry of the first time period; and
transmits, information related to the updated first product profile to the control device of the purchased first product.

14. The first computing device according to claim 8, wherein the circuitry further receives, from a second computing device of a second user, a first request associated with an ownership of the purchased first product, and wherein the first request is a request of the second user to purchase the first product from the first user.

15. The first computing device according to claim 14, wherein the circuitry further deletes the generated first product profile from the first computing device, and transmits information related to the first product profile to the second computing device.

16. The first computing device according to claim 8, wherein the circuitry further:
receives, from a second computing device of a second user, a second request associated with an exchange of the purchased first product owned by the first user with a second product owned by the second user;
receives, from the second computing device, information related to a second product profile associated with the second product;
stores the information related to the second product profile associated with the second product;
updates, via the ownership management software, the first product profile associated with the purchased first product based on the received second request;
transmits information related to the updated first product profile to the second computing device, wherein the second computing device stores the information related to the received first product profile; and
transmits the information related to the updated first product profile to a control device of the purchased first product.

17. A method, comprising:
in a first computing device communicatively coupled to a store management system of a retail store:
determining a first geo-location associated with the first computing device;
receiving credit information, associated with a purchase of a first product by a first user of the first computing device, from the store management system, wherein the received credit information comprises a second geo-location associated with the purchase of the first product;
comparing the determined first geo-location and the second geo-location associated with the purchase of the first product;
receiving product information associated with the purchased first product from the store management system, based on the comparison;
storing the received product information associated with the purchased first product;
based on the stored product information, generating ownership information for the purchased first product via an ownership management software associated with the first computing device; and
controlling a display screen to display the stored product information and the generated ownership information associated with the purchased first product.

18. The method according to claim 17, further comprising:
receiving a first user input indicative of a first operation associated with an update of an ownership of the purchased first product;
updating, via the ownership management software, the ownership information associated with the purchased first product based on the received first user input; and
controlling the display screen to display the product information and the updated ownership information associated with the purchased first product.

19. The method according to claim 18, wherein the first operation associated with the update of the ownership of the purchased first product comprises at least one of: a rent operation, an exchange operation, or a sale operation associated with the purchased first product.

20. A non-transitory computer-readable medium having stored thereon, computer-executable instructions that when executed by a first computing device communicatively coupled to a store management system of a retail store, causes the first computing device to execute operations, the operations comprising:
determining a first geo-location associated with the first computing device;
receiving credit information, associated with a purchase of a first product by a first user of the first computing device, from the store management system, wherein the received credit information comprises a second geo-location associated with the purchase of the first product;
comparing the determined first geo-location and the second geo-location associated with the purchase of the first product;
receiving product information associated with the purchased first product from the store management system, based on the comparison;
storing the received product information associated with the purchased first product;
based on the stored product information, generating ownership information for the purchased first product via an ownership management software associated with the first computing device; and
controlling a display screen to display the stored product information and the generated ownership information associated with the purchased first product.
